(19) United States
(12) Patent Application Publication
(10) Pub. No.: US 2009/0189011 A1
(43) Pub. Date: Jul. 30, 2009

(54) Thrust Vectoring Exhaust Nozzle System for Helicopters

(76) Inventor: Fuat Bahadir, Omaha, NE (US)

Correspondence Address: STINSON MORRISON HECKER LLP;ATTN: PATENT GROUP, 1201 WALNUT STREET, SUITE 2800, KANSAS CITY, MO, 64106-2150, US

(21) Appl. No.: 12/178,991

(22) Filed: Jul. 24, 2008

Related U.S. Application Data
(60) Provisional application No. 61/062,884, filed on Jan. 30, 2008.

(51) Int. Cl. B64C 27/04; B64C 27/08

(52) U.S. Cl. 244/17.11

(57) ABSTRACT

A thrust vectoring exhaust nozzle system for helicopters includes a vertical thrust vectoring nozzle positioned on the rear of the tail of the helicopter and a horizontal thrust vectoring nozzle positioned generally adjacent the vertical thrust vectoring nozzle, the vertical and horizontal thrust vectoring nozzles each connected to the exhaust output of the gas-turbine engine of the helicopter such that by adjusting and controlling the vertical and horizontal thrust vectoring nozzles to direct gas outflow in a selected direction, the exhaust outflow from the engine can be used to assist or modify the movement of the helicopter.

### CROSS-REFERENCE TO RELATED APPLICATIONS

This application is based on and claims priority under 35 U.S.C. §119(e) from applicant's Provisional application Ser. No. 61/062,884 filed Jan. 30, 2008.

### BACKGROUND OF THE INVENTION

1. Field of the Invention

The present invention is directed generally to improved thrust vectoring systems for helicopters and, more particularly, to a thrust vectoring exhaust nozzle system for helicopters having counter-rotating dual rotor systems and which do not have tail rotors, the thrust vectoring system including a vertical thrust vectoring nozzle positioned on the rear of the tail of the helicopter and a horizontal thrust vectoring nozzle positioned generally adjacent and forward of the vertical thrust vectoring nozzle, the vertical and horizontal thrust vectoring nozzles each connected to the exhaust output of the gas-turbine engine such that by adjusting and controlling the vertical and horizontal thrust vectoring nozzles to direct gas outflow in a selected direction, the exhaust outflow from the engine can be used to assist the movement of the helicopter.

2. Description of Related Art

There are many different types of helicopters which are currently in use, including single rotor helicopters, dual rotor helicopters, transverse rotor helicopters, and several other related helicopter-type rotor-based flying aircraft. However, among the different types of helicopters currently being used, it has been found that those with dual rotors are among the most versatile, due to their increased lifting capacity from the increased airflow resulting from the two rotors being used on the aircraft. Primarily, there are three common configurations of dual rotor helicopters which utilize the contra-rotating effect to benefit the rotor craft, the first being a twin rotor design which includes two rotors mounted on the aircraft, one mounted behind the other, the second being intermeshing rotors which are mounted close to each other with the rotor blades intermeshing over the top of the aircraft, and finally a coaxial rotor design which includes two rotors mounted one above the other on the same rotation axis. It has further been found that the coaxial rotor system is generally more cost-effective, as the size of the helicopter does not have to be expanded to accommodate the position of the two rotors as they are positioned one atop the other. A further benefit of the coaxial rotor design is that, in forward flight, the lift provided by the advancing ends of each rotor compensates for the retreating half of the other, eliminating one of the key effects of dissymmetry of lift, namely retreating blade stall.

A further advantage of the coaxial rotor system is that it eliminates the need for a tail rotor to counteract the rotation of the main rotor. However, the elimination of tie tail rotor also eliminates an additional flight control feature, and therefore the operator of the helicopter is dependent entirely on the dual rotors for flight control. While this generally does not present a significant problem, in situations requiring rapid forward, upward and/or downward motion, it would be advantageous to provide an additional control device which can be used to supplement the flight control provided by the dual rotor system.

Also, it should be noted that in the majority of helicopters, the exhaust from the helicopter engine is expelled therefrom at a relatively high rate of speed and with a significant amount of force, yet is merely released into the surrounding atmosphere via any appropriate muffling exhaust system. As this exhaust outflow is present at all times during operation of the helicopter engine, it would be beneficial to utilize this exhaust gas outflow in a manner which would improve the operating efficiency of the helicopter itself.

Therefore, an object of the present invention is to provide an improved thrust vectoring exhaust nozzle system for a helicopter.

Another object of the present invention is to provide an improved thrust vectoring exhaust nozzle system for a helicopter which utilizes the exhaust of a helicopter to provide additional thrust for the helicopter, the thrust being directionable due to the configuration of the system.

Another object of the present invention is to provide an improved thrust vectoring exhaust nozzle system for a helicopter which includes a vertical thrust vectoring nozzle positioned on the rear of the tail of the helicopter and a horizontal thrust vectoring nozzle positioned generally adjacent and forward of the vertical thrust vectoring nozzle.

Another object of the present invention is to provide an improved thrust vectoring exhaust nozzle system for a helicopter in which the vertical and horizontal thrust vectoring nozzles are each connected to the exhaust output of the gas-turbine engine such that by adjusting and controlling the vertical and horizontal thrust vectoring nozzles to direct gas outflow in a selected direction, the exhaust outflow from the engine can be used to assist the movement of the helicopter.

Finally, an object of the present invention is to provide an improved thrust vectoring exhaust nozzle system for a helicopter which is relatively simple in design, economical to manufacture, and is safe, efficient and effective in use.

### BRIEF SUMMARY OF THE INVENTION

The present invention provides, in combination, a helicopter having an main body, a tail section, at least one rotor, an engine operatively connected to the at least one rotor, an air intake opening positioned forwardly of the engine, an air intake flow tube operative to direct inflow air to the engine and a tail tube operative to direct engine exhaust and inflow air rearwards to the tail section and a thrust vectoring exhaust nozzle system mounted thereon. The thrust vectoring exhaust nozzle system includes a vertical thrust vectoring nozzle mounted on the tail section of the helicopter and a horizontal thrust vectoring nozzle mounted on the tail section generally adjacent the vertical thrust vectoring nozzle. The vertical and horizontal thrust vectoring nozzles are each connected to the tail tube such that engine exhaust from the engine and inflow air from the air intake flow tube flows through each of the vertical and horizontal thrust vectoring nozzles and outwards therefrom. The vertical thrust vectoring nozzle includes vertical air flow directing structures operative to redirect air flow through the vertical thrust vectoring nozzles in a selected upwards or downwards direction, and likewise the horizontal thrust vectoring nozzle includes horizontal air flow directing structures operative to redirect air flow through the horizontal thrust vectoring nozzles in a selected left or right direction such that the vertical and horizontal thrust vectoring nozzles are operative to assist vertical and horizontal movement of the helicopter by adjusting and controlling the direction of exhaust outflow from the engine, and therefore the exhaust outflow is usable to assist the movement of the helicopter.

The present invention thus provides a substantial improvement over those systems and methods found in the prior art which are designed to assist movement of the helicopter in the vertical and horizontal planes. First of all, because the system of the present invention utilizes the exhaust gas outflow from the gas turbine engine itself, it takes advantage of a thrust component which already is present on the helicopter and uses it in a beneficial manner. Also, because the present invention provides a supplemental thrust to the rotor thrust already being provided, it is believed that the helicopter outfitted with the present invention will be more maneuverable and therefore safer for pilots and passengers therein. Perhaps most importantly from an operational standpoint, however, the present invention provides the operator of the helicopter several more options to add or adjust vertical or horizontal thrust components, beyond simple adjustment of the rotor swash plates and angle of attack of the rotor blades themselves, which in combat could mean the difference between escaping and being shot down by enemy fire. It is therefore seen that the present invention provides a substantial improvement over those systems and methods found in the prior art.

It is to be further understood that both the foregoing general description and the following detailed description are exemplary and explanatory only and are not necessarily restrictive of the invention as claimed. The accompanying drawings, which are incorporated in and constitute a part of the specification, illustrate at least one embodiment of the invention and together with the general description, serve to explain the principles of the invention.

Additional aspects of the invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means of the instrumentalities and combinations particularly pointed out in the appended claims.

### DESCRIPTION OF THE DRAWINGS

FIG. 1 is a perspective view of a helicopter outfitted with the vertical and horizontal thrust vectoring nozzles of the present invention;

FIG. 2 is a perspective view of the tail of the helicopter showing the vertical and horizontal thrust vectoring nozzles;

FIG. 3 is a detailed side elevational view showing how the exhaust gas outflow may be directed to either of the vertical and horizontal thrust vectoring nozzles in a full or a partial flow of the gas;

FIGS. 4a and 4b are detailed side elevational views showing the movement of the thrust vectoring nozzle vanes which are used to control gas flow through the nozzles; and

FIGS. 5a and 5b are detailed side elevational views of an alternative embodiment of the present invention in which the exhaust gas is divided in three channels instead of into two.

### DESCRIPTION OF THE PREFERRED EMBODIMENT

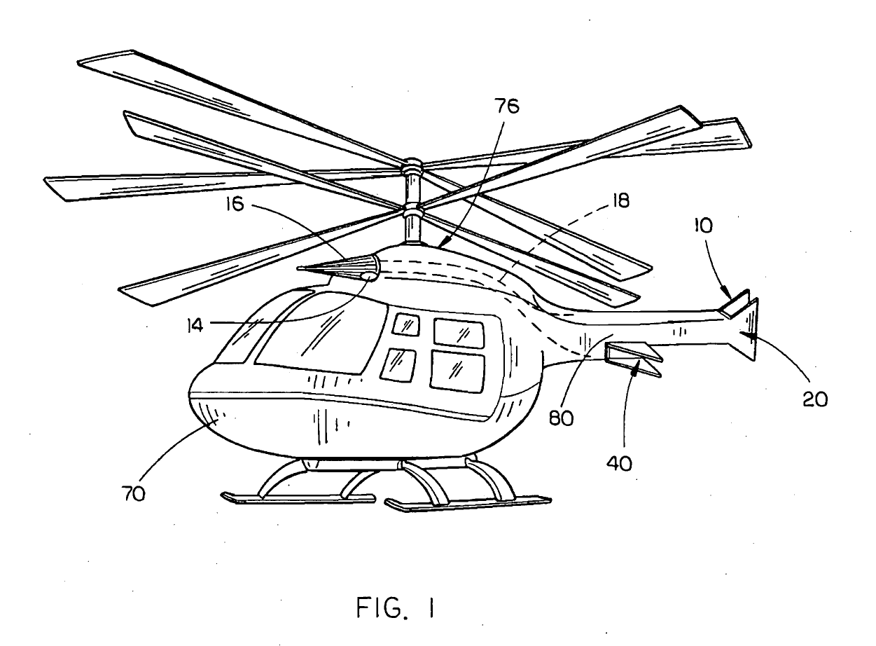

The thrust vectoring exhaust nozzle system 10 of the present invention is shown best in FIGS. 1-4b as being mounted on a helicopter 70 having an engine 76, the system including an air intake opening 14 which is positioned forwardly of the engine 76 and a generally straight air intake flow tube 18 which directs the inflow air into the engine 76 and then directs the exhaust gas outflow rearwards to the tail 80 of the dual rotor helicopter 70 where the thrust vectoring exhaust nozzle system 10 of the present invention is located. In the preferred embodiment, the air intake opening 14 would be covered with a protective grating 16 to prevent entrance of large foreign objects which could damage the air intake, engine or nozzle system, and such protective gratings 16 are known in the prior art. Finally, it should be noted that although it is generally preferred that the air intake flow tube 18 be straight to ensure laminar air flow, curvature of the air intake flow tube 18 to conform to the helicopter body configuration is acceptable, as shown in FIG. 1, so long as the air intake flow tube 18 provides a generally efficient and generally turbulence-free air and exhaust transport channel through the helicopter body between the air intake opening 14 and the thrust vectoring exhaust nozzle system 10.

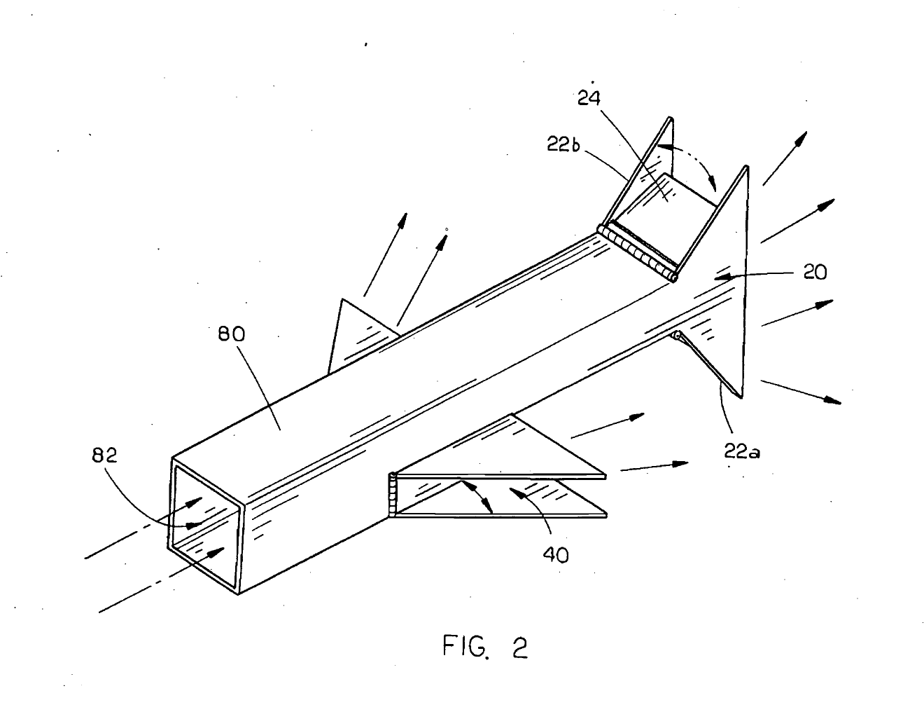

The thrust vectoring exhaust nozzle system 10 of the present invention includes a vertical thrust vectoring nozzle 20 and a horizontal thrust vectoring nozzle 40 each of which are mounted on the tail 80 of a dual rotor helicopter and which are each constructed of a high strength and light weight construction material such as carbon fiber, aluminum or another such construction material currently used in the art. As shown best in FIGS. 1 and 2, it is preferred that the vertical thrust vectoring nozzle 20 be positioned at the end of tail 80, and that the horizontal thrust vectoring nozzle 40 be positioned forward of the vertical thrust vectoring nozzle 20 on tail 80, although the relative positioning of the vertical and horizontal vectoring nozzles 20 and 40 may be modified or changed so long as the intended functionality of the present invention is generally maintained. An important feature of the present invention is that the tail 80 of the helicopter will either be a generally hollow tube 82 or will be a continuation of the air intake tube 14, one that performs the same function as the hollow tube 82 within tail 80. This hollow tube 82 is connected at the opposite end thereof to the exhaust outlet of the helicopter engine and to the air intake tube 14, as shown in FIG. 1, in order to transfer the exhaust gases from the exhaust outlet to the vertical and horizontal thrust vectoring nozzles 20 and 40. It is an important feature of the present invention that the specific type and design of the helicopter engine 76 is not particularly critical to the proper functioning of the present invention in that the exhaust gases and the airflow through the air intake tube 14 will arrive at the vertical and horizontal thrust vectoring nozzles 20 and 40 at a high rate of speed, depending on the motion of the helicopter, and it is the output of these exhaust gases and the airflow through the air intake tube 14 which is usable by the present invention to provide an additional control device for the helicopter.

As the exhaust gases travel rearwards through hollow tube 82 within tail 80 of the helicopter, they encounter exhaust gas flow control vane 50 which, in the preferred embodiment, would be a generally planar panel which is pivotally mounted within the hollow tube 82 of tail 80 such that the flow control vane 50 may be moved within the hollow tube 82 to direct exhaust gas flow to either or both of the vertical and horizontal thrust vectoring nozzles 20 and 40. The flow control vane 50 would preferably be controlled by an electric motor 52 or the like which controls the pivoting movement of the exhaust gas flow control vane 50, and control of the flow control vane 50 would be performed using any appropriate control device which controls operation of the electric motor 52. Of course, it should be noted that many different types of control devices may be used in connection with flow control vane 50 which accomplish the intended purpose of controlling the positioning of the flow control vane 50 within hollow tube 82, such as hydraulic, pneumatic or mechanical devices, and substitution of such other control devices should be understood to be a part of this disclosure and this invention.

The exhaust gas flow control vane 50 is pivotable upwards and downwards, as shown best in FIG. 2, to direct some or all exhaust gas flow into the selected one of the vertical and horizontal thrust vectoring nozzles 20 and 40. It should further be noted that one of the benefits of the design of the present invention is that it is entirely possible to have a virtually infinite number of positions for the flow control vane 50 so that extremely accurate control of the allocation of exhaust gases is possible.

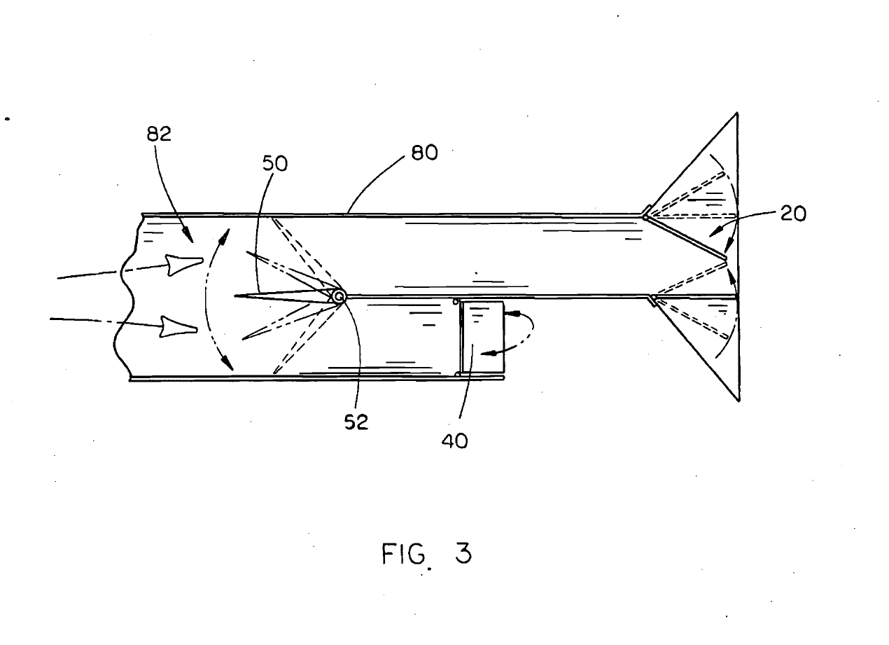

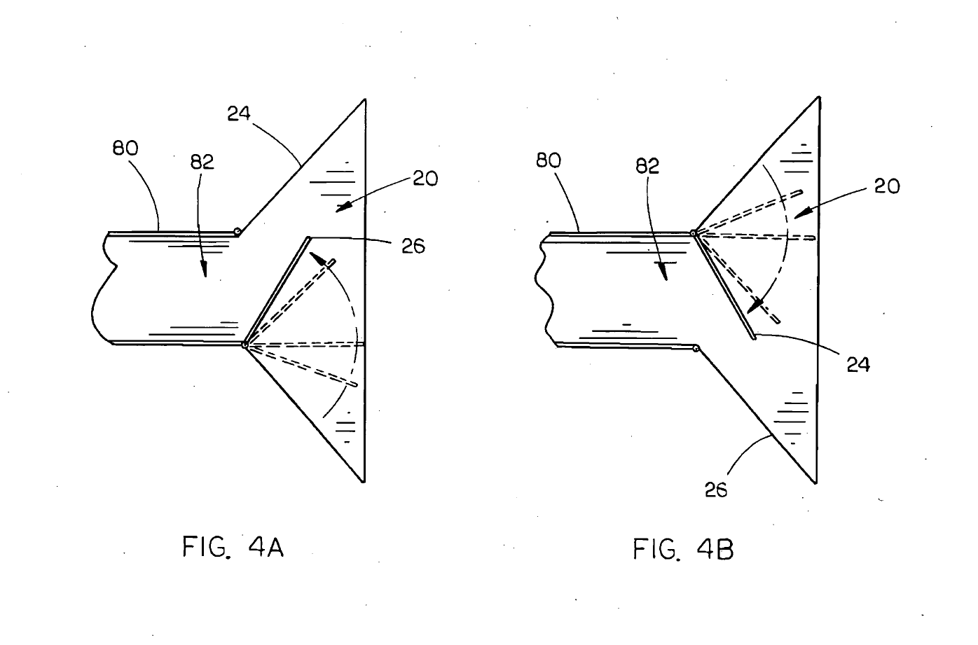

In the preferred embodiment, the vertical and horizontal thrust vectoring nozzles 20 and 40 are generally identical to one another, and therefore the following description or vertical thrust vectoring nozzle 20 should be understood to apply generally equally to the horizontal thrust vectoring nozzle 40, in terms of configuration and operation. The vertical thrust vectoring nozzle 20 is best shown in FIGS. 2, 3, 4a and 4b as including generally trapezoidal side walls 22a and 22b and top and bottom thrust vector vanes 24 and 26 which are pivotally mounted on the tail 80, with the positioning of the top and bottom thrust vector vanes 24 and 26 being controlled in a manner similar to that described in connection with exhaust gas flow control vane 50. Specifically, electric, hydraulic, or pneumatic actuators would be connected to each of the top and bottom thrust vector vanes 24 and 26 to adjust the position of each of the vanes 24 and 26 relative to one another, thus controlling exhaust gas outflow through the vertical thrust vectoring nozzle 20, as shown best in FIGS. 3, 4a and 4b. As exhibited in those Figures, the positions of the top and bottom thrust vector vanes 24 and 26 may be adjusted to not only control the directional outflow of the exhaust gas flowing through hollow tube 82 into vertical thrust vectoring nozzle 20, but also may be used to accelerate the exhaust gas outflow by bringing the top and bottom thrust vector vanes 24 and 26 into closer proximity to one another, thus increasing the gas flow speed through the vertical thrust vectoring nozzle 20 and hence increasing the thrust being provided by the outflow gas from the vertical thrust vectoring nozzle 20. Moreover, the adjustable nature of the top and bottom thrust vector vanes 24 and 26 permits the direction of the outflow gas to be adjusted, and the combination of increased velocity and directional control means that a helicopter 70 outfitted with the present invention may utilize the exhaust gas output of the engine 76 to provide a supplemental control device which is defined by the vertical and horizontal thrust vectoring nozzles 20 and 40.

In operation, the present invention would provide a supplemental control device in that the exhaust gases exiting the engine of the helicopter would be fed through hollow tube 82 within tail 80 towards the exhaust gas flow control vane 50. Depending on how the operator of the present invention desires to allocate the outflow gases, he or she would adjust the positioning of the exhaust gas flow control vane 50 to send a greater or lesser portion of the gas flow to the respective one of the vertical and horizontal thrust vectoring nozzles 20 and 40. The exhaust gas flowing towards the vertical thrust vectoring nozzle 20 then encounters the top and bottom thrust vector vanes 24 and 26 which are positioned to both increase the exhaust gas flow speed and direct the exhaust flow gas in a selected direction, and in accordance with the configuration shown in FIG. 4a, the exhaust gas would be directed rearwards and upwards which will act to force the tail 80 of the helicopter forwards and downwards, thus accelerating the helicopter forwards and simultaneously changing the attitude of the helicopter so that changes in direction and attack angle may be more quickly and accurately facilitated, thereby significantly increasing the agility of the helicopter. For example, when the helicopter needs a sharp left or right turn, the exhaust gas flow control vane 50 would be adjusted to divert most or all of the exhaust gas outflow into the horizontal thrust vectoring nozzle 40, thus providing substantially increased power to the horizontal thrust vectoring nozzle 40. In a similar manner, if the helicopter needs to make a sudden dive down or rapidly increase altitude, most or all of the exhaust gas outflow could be diverted to the vertical thrust vectoring nozzle 20 thus providing substantially increased power to the horizontal thrust vectoring nozzle 40.

Likewise, exhaust gas flowing through horizontal thrust vectoring nozzle 40 would be directed by the thrust vector vanes positioned therein to force the tail 80 left or right depending on the configuration of the vanes within horizontal thrust vectoring nozzle 40. Therefore, by adjusting all of the thrust vector vanes within the vertical and horizontal thrust vectoring nozzles 20 and 40, the operator of the present invention may significantly supplement his or her control of the helicopter 70.

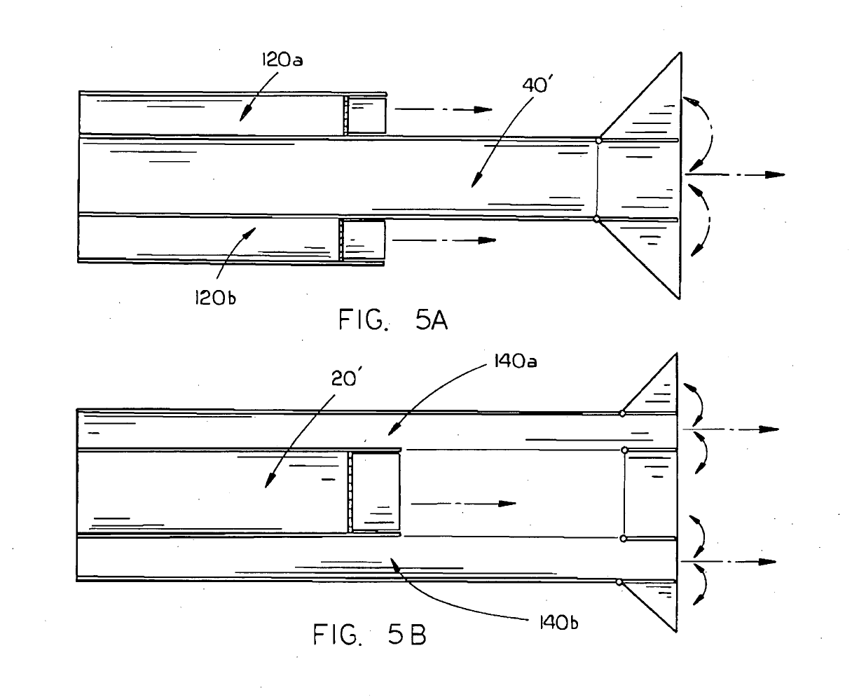

Shown in FIGS. 5a and 5b is another embodiment of the present invention in which the exhaust gas is divided in three instead of in two, with either the vertical or the horizontal thrust vectoring nozzles being divided into two separate nozzles surrounding the other nozzle. Specifically, FIG. 5a shows a configuration including two horizontal thrust vectoring nozzles 120a and 120b with a single vertical thrust vectoring nozzle 40′, and FIG. 5b shows a configuration including two vertical thrust vectoring nozzles 140a and 140b with a single horizontal thrust vectoring nozzle 20′, with the exhaust gas being divided approximately fifty percent (50%) to tbe single nozzle and fifty percent (50%) to the dual nozzles, thus each of the dual nozzles will receive approximately twenty-five percent (25%) of the available exhaust gas outflow. The other operational elements will remain generally the same as previously described in connection with the embodiment of FIGS. 1-4b, and therefore operation of this embodiment will be generally similar. However, it is believed that this configuration will likely enhance helicopter performance for some helicopter designs, and therefore may be used with such designs.

It is to be understood that numerous additions, modifications and substitutions may be made to the thrust vectoring exhaust nozzle system 10 of the present invention which fall within the intended broad scope of the above description. For example, the size, shape, and construction materials used in connection with the vertical and horizontal thrust vectoring nozzles 20 and 40 may be modified or changed so long as the intended functional features of the present invention are neither significantly degraded nor destroyed. Furthermore, the control mechanisms used in connection with the top and bottom thrust vector vanes 24 and 26 and the exhaust gas flow control vane 50 may be modified or changed so long as the functionality of the elements remains generally intact. Finally, although the present invention has been described for use generally in connection with coaxial dual rotor helicopters, virtually any helicopter not including a tail rotor may incorporate the thrust vectoring exhaust nozzle system 10 of the present invention and such inclusion should be understood to be a part of this disclosure.

The thrust-vectoring system 10 of the present invention may also used with single rotor helicopters. In that case, the extra rotational force, caused by the single rotor, could be counter-balanced by the horizontal thrust-vectoring nozzle by directing it a little bit extra left or right. This extra adjustment can be done automatically, without the need for the adjustment to be done by the pilot, by using an electronic sensor circuit that would read the current rotation speed of the rotor and make the extra adjustment.

There has therefore been shown and described a thrust vectoring exhaust nozzle system 10 for helicopters which accomplishes at least all of its intended objectives.

I claim:

1. In combination:
a helicopter having an main body, a tail section, at least one rotor, an engine operatively connected to said at least one rotor, an air intake opening positioned forwardly of said engine, an air intake flow tube operative to direct inflow air to said engine and a tail tube operative to direct engine exhaust and inflow air rearwards to said tail section;
a thrust vectoring exhaust nozzle system comprising a vertical thrust vectoring nozzle mounted on said tail section of said helicopter; and
a horizontal thrust vectoring nozzle mounted on said tail section generally adjacent said vertical thrust vectoring nozzle,
said vertical and horizontal thrust vectoring nozzles each being connected to said tail tube such that engine exhaust and inflow air from said air intake flow tube and said engine flows respectively through each of said vertical and horizontal thrust vectoring nozzles and outwards therefrom,
said vertical thrust vectoring nozzle including a vertical air flow directing structure operative to redirect air flow through said vertical thrust vectoring nozzle in a selected upwards or downwards direction,
said horizontal thrust vectoring nozzle including a horizontal air flow directing structure operative to redirect air flow through said horizontal thrust vectoring nozzle in a selected left or right direction such that said vertical and horizontal thrust vectoring nozzles are operative to assist vertical and horizontal movement of said helicopter by utilizing engine exhaust from said engine.

2. The combination of claim 1 wherein said engine is a gas turbine engine.

3. The combination of claim 1 wherein said helicopter is a dual rotor helicopter.

4. The combination of claim 1 wherein said helicopter includes a tail having a distal end and said vertical thrust vectoring nozzle is positioned at said distal end.

5. The combination of claim 4 wherein the horizontal thrust vectoring nozzle is positioned forwardly of the vertical thrust vectoring nozzle.

6. The combination of claim 1 wherein said helicopter includes a hollow tail operable for transferring exhaust gases from the engine to the thrust vectoring nozzles.

7. The combination of claim 6 wherein is included a flow control vane operable for directing flow of exhaust gases toward said nozzles.

8. A thrust vectoring exhaust nozzle system for helicopters having counter-rotating dual rotor systems comprising:
a first thrust vectoring nozzle mounted on said tail section of a said helicopter; and
a second thrust vectoring nozzle mounted on said tail section generally adjacent said first thrust vectoring nozzle,
said first and second thrust vectoring nozzles each being adapted to be connected to the exhaust output of an engine of a helicopter,
said first and second thrust vectoring nozzles each being operative to direct the exhaust output in a respective selected direction, such that by adjusting and controlling the direction of exhaust outflow from the engine, the exhaust outflow is usable to assist the movement of the helicopter.

9. The thrust vectoring exhaust nozzle system for helicopters of claim 8 wherein said thrust vectoring nozzles are essentially identical.

10. The thrust vectoring exhaust nozzle system for helicopters of claim 8 wherein said nozzles include generally trapezoidal sidewalls.

11. The thrust vectoring exhaust nozzle system for helicopters of claim 8 wherein said nozzles each include an adjustable vector vane for controlling exhaust gas how therethrough.

12. The thrust vectoring exhaust nozzle system for helicopters of claim 11 wherein said vanes are generally planar panels.

13. The thrust vectoring exhaust nozzle system for helicopters of claim 8 wherein one of said nozzles directs the flow of exhaust in a generally horizontal direction while the other of said nozzles directs the flow of exhaust in a generally vertical direction.

14. The thrust vectoring exhaust nozzle system for helicopters of claim 8 wherein is included a third nozzle for directing the flow of exhaust gases in essentially the same direction as one of said first and second nozzles.

15. The thrust vectoring exhaust nozzle system for helicopters of claim 8 wherein said nozzles are constructed of light weight construction material.

16. A thrust vectoring exhaust nozzle system for a helicopter, said system comprising:
a first thrust vectoring nozzle adapted to be positioned on a helicopter; and
a second thrust vectoring nozzle adapted to be positioned on said helicopter,
said nozzles each being connectable to the exhaust output of an engine of the helicopter,
said nozzles each being operable to direct gas outflow in a respective selected direction such that by adjusting and controlling the direction of exhaust outflow from the engine, the exhaust outflow is usable to assist the movement of the helicopter.
